(19) United States
(12) Patent Application Publication
(10) Pub. No.: US 2004/0236884 A1
(43) Pub. Date: Nov. 25, 2004

(54) File analysis

(76) Inventor: Andreas Beetz, Berkshire (GB)

Correspondence Address: SHAW PITTMAN, IP GROUP, 1650 TYSONS BOULEVARD, SUITE 1300, MCLEAN, VA, 22102, US

(21) Appl. No.: 10/343,048

(22) PCT Filed: Jul. 30, 2001
(86) PCT No.: PCT/GB01/03398

(30) Foreign Application Priority Data
Jul. 28, 2000 (GB) 0018682.5

(51) Int. Cl. G06F 13/38

(52) U.S. Cl. 710/68

(57) ABSTRACT

A method of analysing the properties of an electronic file, especially to detect a packed executable file. A neural network is used to determine if a given file is a packed executable from analysis of byte distributions within the file without unpacking the fiel from its compressed form.

### TECHNICAL FIELD TO THE INVENTION

This invention relates to networked and stand-alone computer systems in general and security protection against virus attacks in particular. More specifically, this invention concerns a method for detecting packed executable electronic files.

### DESCRIPTION OF RELATED ART

Recent years have witnessed a proliferation in the use of the Internet. Many stand-alone computers and local area networks connect to the Internet for exchanging various items of information and/or communicating with other networks.

Such systems are advantageous in that they can exchange a wide variety of different items of information at a low cost with servers and networks on the Internet.

However, the inherent accessibility of the Internet increases the vulnerability of a system to threats such as viruses and cracker attacks. Around 5-10 new viruses are discovered each day on the popular Windows-based operating systems. Although most spread through the Internet, for example through file attachments or email worms, stand-alone machines may also be infected by a floppy disc or other removable media. The concern for advanced security solutions for both stand-alone and networked computers is therefore substantial.

The principle of operation of conventional antiviral software is commonly based on a combination of checks of files, sectors and system memory. Particularly popular are anti-virus scanners, which search such objects in conjunction with a database of known “virus signatures”, or code sequences characteristic of a given virus.

Whilst effective at detecting known viruses, such scanning methods are of limited use in recognizing viruses not listed in the database. For this reason, the database needs to be updated regularly as new viruses are discovered frequently.

Cyclic redundancy check (CRC) scanners adopt an alternative approach by calculating checksums for actual disk files or system sectors. These checksums are then saved to the anti-virus program's database with other data such as file size, date of last modification, and other characteristics. On subsequent runs, the CRC scanner monitors currently calculated checksum values against the database information. If the database entry for a file differs from the file's current characteristics, the CRC scanner will report file modification or possible virus infection.

Such a generic tool is successful at detecting virus activity without the need to be updated in order to recognize new viruses. An integral drawback, however, is that a CRC scan cannot catch a virus immediately after its infiltration but only after some time, when the virus has already spread over the computer system or network. Furthermore, CRC scanners cannot detect viruses in newly arrived files such as email attachments or restored backup files as the CRC database would not have existing entries for such files. In addition, viruses are known which purposely infect only newly created files, in order to appear invisible to CRC scanners.

Recently, a new content threat has been developed, known as the “packed” virus. Packing involves compressing an executable file but leaving it in an executable state. An infected executable can thereby be changed by the packing process such that its signature becomes completely different whilst remaining executable. Such compressed executables may be created by compression utilities, typically ZIP2EXE, familiar to those skilled in the art, or through use of any available compressor algorithm.

Conventional antiviral scanners generally fail to recognize such packed variants of viruses. Compressed archives, on the one hand, can easily be recognised as such by their filetype, as customarily indicated in the file suffix (.ZIP, .ARJ, CAB and .LZ being common examples). Furthermore, although file suffixes are not mandatory, it is customary within the art to reserve a series of bytes, known as the “header”, at the beginning of an electronic file for designating the proprietary format of the file. This allows other software programs and the operating system to recognise files as being for use with a particular program and comprises a useful means for determining filetypes.

Packed files, on the other hand, retain executable characteristics and, although the header may contain section names generated by specific packers, cannot easily be recognised as containing compressed data.

It follows that anti-virus scanners will thus fail to detect packed executables until the software vendors release an updated pattern file aware of such viruses. However, in order to remain comprehensive, the corresponding database libraries have to increase rapidly in size in view of all the popular compression algorithms available. As a result, this approach is contrary to the general desire for resident virus scanners to be relatively compact, fast in execution, and economical on system resources. Furthermore, such an approach remains incapable of detecting an executable that has been packed using a custom compression algorithm written by the virus author and containing corresponding decompression code.

Performing CRC checksums is a more generic detection method and therefore may be applied. Although capable of detecting an attack by a packed virus, this technique cannot catch a virus immediately after its infiltration but only after some time, when the virus has already spread over the computer system or network, as explained above.

A known approach involves temporarily opening ad unpacking the .EXE file to gain contents to the files inside and examining the file contents uncompressed. However, opening and unpacking the file may expose the computer system to viral infection. Furthermore, this approach cannot be used for encrypted packed files which can only be accessed using a password. Such files are commonly placed in a “quarantine zone” for review by a system administrator, placing a demand on resources.

There is therefore a need for a computer-implemented method of analysing electronic files to detect packed executables.

### SUMMARY OF THE INVENTION

In accordance with one aspect of the present invention, there is provided a method for determining the properties of an electronic file, said method comprising:

analysing byte distributions of the file contents; determining properties of the electronic file with respect to the analysis.

This has the advantage that it allows the possibility of recognising file properties of both known and unknown files of similar characteristics, because similar file formats possess similar byte distributions.

Preferably, the analysing of byte distributions comprises a determining step in which the frequency of occurrence of the byte distributions of the file contents is determined. Such a frequency analysis is advantageous in detecting compressed data as effective compression techniques tend to increase the entropy of byte distributions in the file.

Preferably, the step of determining properties of the electronic file includes use of a neural network, and means may be included for training the neural network on sample packed files. This has the advantage of being capable of ascertaining distinctive characteristics in the byte distributions which are common to packed files compressed using both known packer algorithms and unknown packer algorithms.

Preferably, the method of determining properties of the electronic file is able to recognize compressed files. Preferably, said method is performable without unpacking data in the file from its compressed form. The inventive method is therefore advantageous as compressed files may be examined without need for decompression of the contents which may subject the system to potential viral infection. Furthermore, some compressed files, such as ZIP files, may use a form of encryption to lock the file against unauthorised access and so cannot be decompressed without use of a password. Therefore, information on the file contents cannot be gained by conventional methods. The inventive method allows the locked compressed files to be examined without need for decompressing the contents and so may be performed without use of a password.

In accordance with a second aspect of the present invention, there is provided a software product which contains code for implementing the method of the first aspect.

In accordance with a third aspect of the present invention, there is provided a computer system enabled to implement the method of the first aspect.

Thus, the system provides the user with an additional layer of security against threats from packed viruses.

### BRIEF DESCRIPTION OF THE DRAWINGS

FIG. 1 is a block diagram of part of a computer network operating in accordance with the invention.

FIG. 2 illustrates operation of a software product in accordance with the invention.

### DETAILED DESCRIPTION OF THE PREFERRED EMBODIMENTS OF THE INVENTION

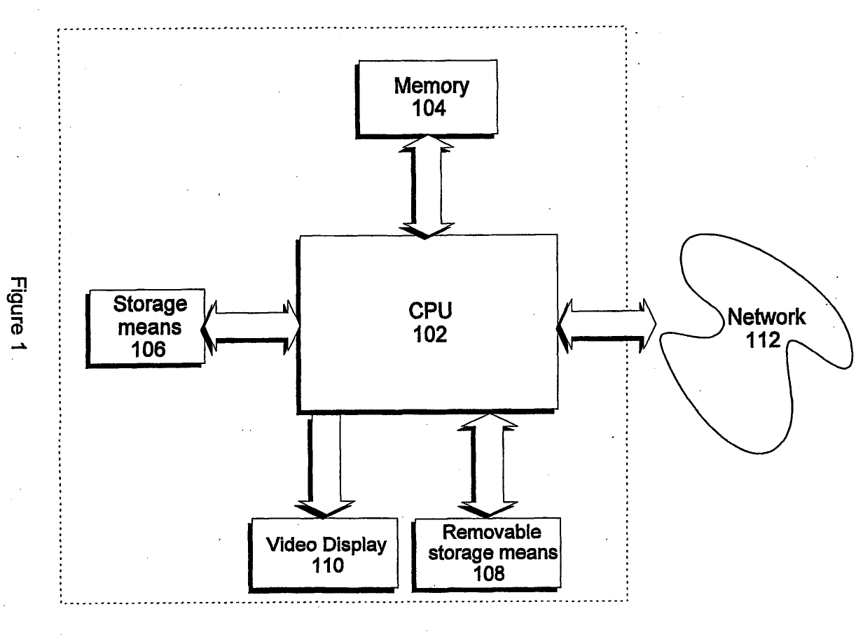

FIG. 1 of the accompanying drawings illustrates functional blocks of a computer system 100 operable in accordance with the present invention. Computer system 100 may comprise a stand alone or networked desktop, portable or handheld computer, networked terminal connected to a server, or other electronic device with suitable communications means. Computer system 100 comprises a central processing unit (CPU) 102 in communication with a memory 104. The CPU 102 can store and retrieve data to and from a storage means 106, and can retrieve and optionally store data from and to a removable storage means 108 (such as a CD-ROM drive, ZIP drive or floppy disc drive). CPU 102 outputs display information to a video display 110.

Computer system 100 may be connected to and communicate with a network 112 such as the Internet, via a serial, USB (universal serial bus), Ethernet or other connection.

Alternatively, network 112 may comprise a local area network (LAN), which may then itself be connected through a server to another network (not shown) such as the Internet.

Computer system 100 may further comprise input means such as a mouse and/or keyboard (not shown) and output peripherals such as a printer or sound generation hardware, as customary in the art. Computer system 100 runs operating system software which may be stored on disc or provided in read-only memory (ROM). Data files such as documents or software programs may be transferred to computer system 100 via removable storage means 108 or through network 112.

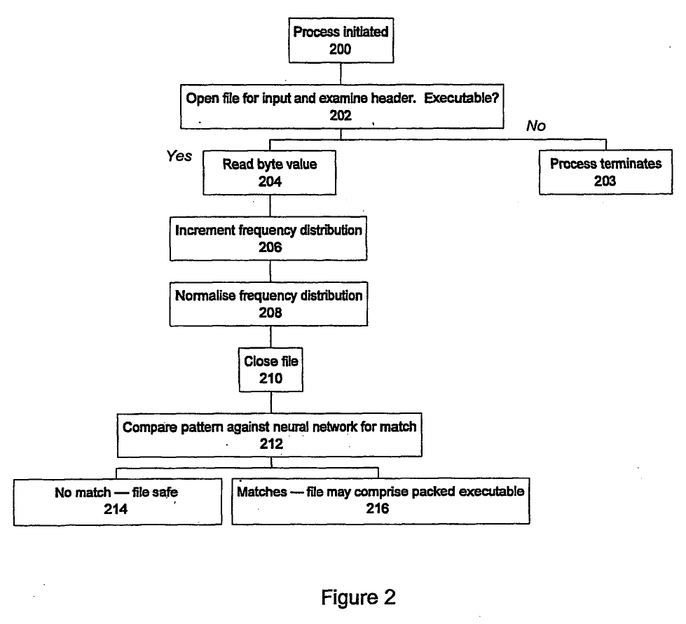

Reference will now be made to FIG. 2, which describes the operation of an embodiment of the software in accordance with the invention. The software may be loaded when required, or preferably is loaded permanently and remains quiescent until a file check is initiated, either automatically or by action of a user. In step 200, the software intercepts an attempt either to load an unknown file to the system memory or to copy said file into a different part of the network. The attempt to load the file may be actioned by a user, or invoked through software running on computer system 100. The file may comprise an email attachment, for example, or an image or document, or one of a number of different filetypes as known in the art. In step 202, the file is opened as a binary data stream by the software, and the header information read to ascertain whether the file is an executable. It is common practice amongst virus authors to intentionally mislabel file suffixes of executable files, to mislead users into believing that the files are harmless.

If the header information pertains to a known filetype other than an executable file, the process is terminated, allowing loading to proceed. However, if the header information pertains to an executable file or is ambiguous, the process continues with the steps below:

Each byte is read from the file either sequentially or as a block in step 204 and stored in memory. For conventional 8-bit data, each byte has a value in the range 0-255. In step 206, the cumulative frequency of occurrence of this value in the file is stored.

The steps 204, 206 of reading each successive byte from the binary data stream and updating the numbers of occurrences of byte values are repeated until the end of the file (EOF) marker is reached. The frequency distribution is then normalised by the file size in step 208 to give the proportion of each byte in the file.

It will be understood that this aspect of the process, is subject to variations as customary in the art. For example, the data may be read from the file as a contiguous block, divided by the file length and then the corresponding normalised frequency distribution of byte values generated to reduce computation time.

Finally, the file is disconnected from the specific stream by using a close operation 210.

Having received this information, the software takes this normalised frequency distribution of the proportion of each byte in the file and, in step 212, applies it to a neural network, which generates a percentage confidence indication as to whether the file is a compressed executable file on the basis of its training session, as described later. On the basis of the percentage confidence, the network decides whether or not to treat the file as a compressed executable file.

If the pattern is not sufficiently closely matched (step 214), the file is not treated as a packed executable. The software may then return to its quiescent state and allow loading to proceed (it may happen that other software may now subsequently be invoked, e.g. a conventional virus pattern-scanner)

Alternatively, if the software has detected that file is, or may be, a compressed executable (step 216), the software may alert the user that this is the case, for example by displaying a message on the video display 110. Further, the software may change the file attributes so that the file may not be loaded other than by a system administrator, and/or may place the file in a “quarantine zone”: an area of filespace with restricted access for review by a system administrator. Such quarantine zones are customary in the art, e.g. used by junk and spam mail filtering programs to filter mail which is thought to be unsolicited.

The training of a neural network in accordance with the software of the invention is largely conventional apart from the data that is applied. The neural network is a simple three layer feed forward associative net (that is, with one layer of hidden nodes) comprising 256 input layer nodes in a 256×1 array corresponding to the 256 possible byte values.

The training of the neural network involves collecting a large number of files with known attributes i.e. packed or unpacked, and passing the relevant information into the network. The information passed to the neural network comprises the proportion of each byte value (in the range 0-255) in the target file (calculated by taking the frequency of occurrence of each byte value in the file and normalising by the file size) and a value (0 or 1) to specify whether the file is compressed or uncompressed. The most common method is to set the input of the network to one of the desired patterns and evaluate the output state. The network can then be trained by adjusting the thresholds and weightings of the links, represented by variables, to produce the desired output. Once the network has finished training and it is 100% accurate with the training data, a testing session will follow on the resulting network pattern. The results from the testing session will inform whether the network needs to be retrained.

The neural network will therefore examine all tested files for patterns which it can recognise. For example, when testing for compressed executable files, one pattern which may emerge is that all compressed files have a relatively flat byte distribution. That is, the most commonly occurring byte occurs more often than the least commonly occurring byte, by a relatively low factor. This is because such a distribution indicates a relatively efficient packing algorithm. However, the user of the system does not need to know what patterns are examined by the neural network.

Such a network has been found to have a higher percentage success rate than conventional methods even when tested on executables packed using algorithms on which the network has not been trained, because all successful packing algorithms tend to produce similar byte distributions.

Extra layers may be added to improve the performance of the neural network—the more nodes the network contains, the better the ability of the network to recognise packed files accurately, and the more patterns it can recognize.

A software product which implements the method described above is preferably supplied with the neural network having been trained on packed files. The software product may advantageously allow the neural network to be trained further. For example, the user may have the facility to train the network on actually received packed files. Alternatively, the user may be able to download additional training data, provided by the product supplier, in the form of other packed files. As a further alternative, the user may be able to train the neural network on a filetype which differs from that on which the network was originally trained.

The generic method may be applied with suitable modifications to data formats other than executables such as documents, images, audio formats and moving video content.

There is thus described a method, software product and a computer system which provide for detecting packed executable files.

It is noted that the various options described above may be programmed or configured by a user and that the above detailed description of preferred embodiments of the invention is provided by way of example only. Other modifications which are obvious to a person skilled in the art may be made without departing from the true scope of the invention, as defined in the appended claims.

1. A method for determining the properties of an electronic file, said method comprising:
analysing byte distributions of the file contents; and
determining properties of the electronic file with respect to the analysis.

2. A method as claimed in claim 1, in which the analysing of byte distributions comprises a determining step in which the frequency of occurrence of the byte distributions of the file contents is determined.

3. A method as claimed in claims 1 or 2, in which the step of determining properties of the electronic file includes use of a neural network.

4. A method as claimed in claim 3, in which the neural network has been trained on sample packed executable files.

5. A method as claimed in claims 1-4, in which the step of determining is able to recognize compressed files.

6. A method as claimed in any preceding claim, in which, if the file is determined to be compressed, it is not unpacked from its compressed form.

7. A software product for determining the properties of an electronic file, said software containing code for:
analysing byte distributions of the file contents; and
determining properties of the electronic file with respect to the analysis.

8. A software product as claimed in claim 7, in which the analysing of byte distributions comprises a determining step in which the frequency of occurrence of the byte distributions of the file contents is determined.

9. A software product as claimed in claims 7 or 8, in which the step of determining properties of the electronic file includes use of a neural network.

10. A software product as claimed in claim 9, in which the neural network has been trained on sample packed executable files.

11. A software product as claimed in any of claims 7-10, in which the step of determining is able to recognize compressed files.

12. A software product as claimed in any of claims 7-11, in which the file if containing compressed data is not unpacked from its compressed form.

13. A software product as claimed in claim 9, wherein the neural network can be further trained on additional sample files.

14. A computer system capable of determining the properties of an electronic file, the computer system being enabled to:
analyse byte distributions of the file contents.
determine the file properties from the analysis.

15. A computer system as claimed in claim 14, in which the analysing of byte distributions comprises a determining step in which the frequency of occurrence of the byte distributions of the file contents is determined.

16. A computer system as claimed in claims 14 or 15, in which the step of determining properties of the electronic file includes use of a neural network.

17. A computer system as claimed in claim 16, in which neural network has been trained on sample packed executable files.

18. A computer system as claimed in claims 14-17, in which the step of determining is able to recognize compressed files.

19. A computer system as claimed in any of claims 14-18, in which the file if containing compressed data is not unpacked from its compressed form.

20. A computer system as claimed in claim 16, wherein the neural netwok can be further trained on additional sample files.
